(19) United States
(12) Patent Application Publication
(10) Pub. No.: US 2016/0350484 A1
(43) Pub. Date: Dec. 1, 2016

(54) METHOD AND APPARATUS FOR MANAGING MEDICAL METADATABASE

(71) Applicant: SAMSUNG SDS CO., LTD., Seoul (KR)

(72) Inventors: Ju Youn SON, Seoul (KR); Seong Won BAK, Seoul (KR)

(73) Assignee: SAMSUNG SDS CO., LTD., Seoul (KR)

(21) Appl. No.: 14/982,770

(22) Filed: Dec. 29, 2015

(30) Foreign Application Priority Data
May 27, 2015 (KR) 10-2015-0073759

(51) Int. Cl. G06F 19/00; G06F 17/30

(52) U.S. Cl. CPC G06F 19/322; G06F 19/321; G06F 17/30598; G06F 17/30525

(57) ABSTRACT

Provided is a method of managing a medical metadatabase. The method includes: classifying a plurality of pieces of annotation information into annotation groups according to a predetermined classification standard; determining a common annotation area of each annotation group using annotation area information of each piece of annotation information included in each annotation group; and configuring a metadatabase which matches a patient's clinical information related to each piece of annotation information included in each annotation group to the common annotation area, wherein each piece of annotation information includes annotation area information in a medical reference image.

This application claims priority from Korean Patent Application No. 10-2015-0073759 filed on May 27, 2015 in the Korean Intellectual Property Office, the disclosure of which is incorporated herein by reference in its entirety.

### BACKGROUND OF THE INVENTION

1. Field of the Invention

The present invention relates to a method and apparatus for managing a medical metadatabase, and more particularly, to a method and apparatus for utilizing annotation information as medical information by configuring a metadatabase that matches a patient's annotation information added onto a medical reference image to the patient's clinical information.

2. Description of the Related Art

An electronic medical record system refers to a system that computerizes medical information created in a hospital by combining conventional paper medical records with information and communications technology. Using the electronic medical record system, a user can easily input/store and retrieve/modify medical information such as each patient's medical history, diagnosis results and medical test results.

In the medical field, there is a strong tendency to avoid decision-making by a system using medical information instead of by a medical staff. For this reason, there are more demands for the field of providing medical information to medical staff than for the field of automatic decision-making by a system using medical information. Therefore, a considerably high-level utilization system has already been established in the field of processing standardized medical information using the electronic medical record system and providing the processed medical information.

Meanwhile, annotation information about a patient is written by a medical staff member and added onto a medical reference image. Since the annotation information is stored as simple vector data, it is a typical example of unstandardized medical information. For this reason, it is difficult to retrieve the annotation information added onto the medical reference image from the conventional electronic medical record system and view the annotation information until a medical staff member opens an electronic medical record viewer and views the annotation information. That is, it is difficult to identify which mark has mostly been made in which medical reference image and which disease or operation is related to the mark until a medical staff member views each piece of annotation information through the electronic medical record viewer.

### SUMMARY OF THE INVENTION

Aspects of the present invention provide a method and apparatus for managing a metical metadatabase.

Aspects of the present invention also provide a method of searching a medical metadatabase.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a method of managing a medical metadatabase. The method includes: classifying a plurality of pieces of annotation information into annotation groups according to a predetermined classification standard; determining a common annotation area of each annotation group using annotation area information of each piece of annotation information included in each annotation group; and configuring a metadatabase which matches a patient's clinical information related to each piece of annotation information included in each annotation group to the common annotation area, wherein each piece of annotation information includes annotation area information in a medical reference image.

According to another aspect of the present invention, there is provided a method of searching a medical metadatabase. The method includes: receiving a user's input for selecting an annotation area in a medical reference image; searching a metadatabase for annotation groups having common annotation areas that overlap the selected annotation area; and providing a patient's clinical information related to each piece of annotation information included in each of the found annotation groups.

According to another aspect of the present invention, there is provided an apparatus for managing a medical metadatabase. The apparatus includes: an annotation group classification unit which classifies a plurality of pieces of annotation information into annotation groups according to a predetermined classification standard; a common annotation area determination unit which determines a common annotation area of each annotation group using annotation area information of each piece of annotation information included in each annotation group; and a metadatabase configuration unit which configures a metadatabase that matches a patient's clinical information related to each piece of annotation information included in each annotation group to the common annotation area, wherein each piece of annotation information includes annotation area information in a medical reference image.

According to another aspect of the present invention, there is provided a computer program coupled to a computing device and stored in a recording medium so as to classify a plurality of pieces of annotation information into annotation groups according to a predetermined classification standard; determine a common annotation area of each annotation group using annotation area information of each piece of annotation information included in each annotation group; and configure a metadatabase which matches a patient's clinical information related to each piece of annotation information included in each annotation group to the common annotation area, wherein each piece of annotation information includes annotation area information in a medical reference image.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram illustrating annotation information used in some embodiments of the present invention, specifically, annotation information about a patient which is added onto a medical reference image;

FIG. 2 is a diagram illustrating an electronic medical record used in some embodiments of the present invention, specifically, a patient's annotation information and clinical information stored in an electronic medical record;

FIG. 3 is a flowchart illustrating a method of managing a medical metadatabase according to an embodiment of the present invention;

FIG. 4 is a diagram illustrating a tree structure of annotation groups that can be referred to in some embodiments of the present invention;

FIGS. 5 through 8 are diagrams illustrating various methods of overlapping annotation areas according to some embodiments of the present invention;

FIG. 9 is a flowchart illustrating a method of searching a medical metadatabase according to an embodiment of the present invention;

FIG. 10 is a diagram illustrating a process of searching a medical metadatabase according to embodiments of the present invention;

FIG. 11 is a diagram illustrating a process of searching for a common annotation area according to embodiments of the present invention;

FIG. 12 is a diagram illustrating an example graphic user interface (GUI) for writing an electronic medical record according to embodiments of the present invention;

FIG. 13 is a block diagram of an apparatus for managing a medical metadatabase according to an embodiment of the present invention; and

FIG. 14 is a diagram illustrating the hardware configuration of the apparatus of FIG. 13.

### DETAILED DESCRIPTION OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps and/or operations but do not preclude the presence or addition of one or more other components, steps and/or operations. As used herein, the term “and/or” includes any and all combinations of one or more of the associated listed items.

Hereinafter, the present invention will be described in more detail with reference to the attached drawings.

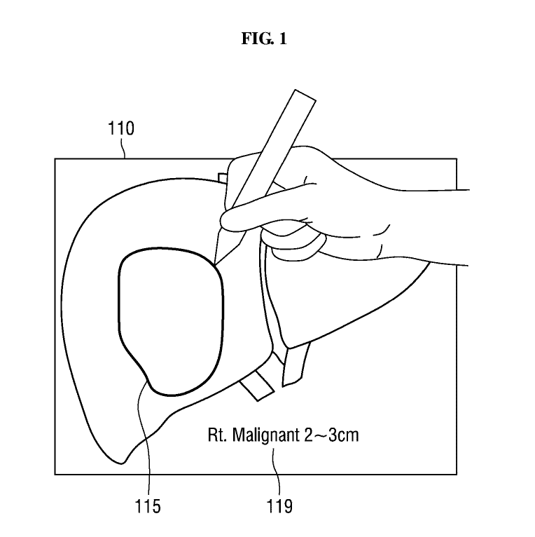

FIG. 1 is a diagram illustrating annotation information used in some embodiments of the present invention, specifically, annotation information about a patient which is added onto a medical reference image.

Referring to FIG. 1, a user of an electronic medical record system inputs annotation information about a patient onto a medical reference image 110.

Here, the medical reference image 110 is a reference image of each body part which is irrelevant to an actual medical image (e.g., an X-ray image or an ultrasound image of a particular body part) of the patient. In FIG. 1, a reference image of the liver is illustrated as an example. However, medical reference images of various body parts such as the stomach, small intestine, hands, feet, etc. can be provided.

The user may be a medical staff member such as a doctor, a nurse, or a health professional who conducts medical tests. User-related details such as a personalization function for each user and an overlap weight will be described in detail later together with some embodiments of the present invention.

The user may mark an area in the medical reference image 110 and input brief information about the area, that is, the patient's medical information such as medical examination results, medical test results, etc. The area marked in the medical reference image 110 will hereinafter be referred to as an annotation area 115, and the brief information about the annotation area 115 will hereinafter be referred to as annotation content 119.

The annotation area 115 is converted into vector data referred to as annotation area information and stored as annotation information in the electronic medical record system together with annotation content text. In addition to writing the annotation information, the user inputs and stores detailed information about the patient as clinical information.

In summary, the annotation information and the clinical information of a patient are stored and managed in the electronic medical record system. This will now be described in detail with reference to FIG. 2.

FIG. 2 is a diagram illustrating an electronic medical record used in some embodiments of the present invention, specifically, a patient's annotation information and clinical information stored in an electronic medical record.

Referring to FIG. 2, medical information about a patient is stored in the electronic medical record system as an electronic medical record 120. Here, the medical information about the patient may largely be divided into annotation information 130 and clinical information 140.

The annotation information 130 may also be divided into image information 131 indicating information about a medical reference image 110, annotation area information 135 indicating an annotation area 115, and annotation content text 139 indicating annotation content 119 of the annotation area 115.

The image information 131 may be code information of the medical reference image 110 managed in the electronic medical record system. The image information 131 indicates to which medical reference image 110 the annotation information 130 is added.

The annotation area information 135 may be vector data of the annotation area 115 input by a user onto the medical reference image 110. For example, information about the annotation area 115 input by the user may be converted into the vector data by dividing the medical reference image 110 into pixels and providing each pixel with coordinates. That is, the annotation area 115 input by the user may be converted into the vector data such as {(x11,y11), (x12,y12), . . . , (xj,yj)} and stored accordingly,

The annotation content text 139 may be brief information about the annotation area 115 input by the user. The annotation area information 135 may be stored as the vector data, but the annotation content text 139 input by the user may be converted into text data through handwriting recognition and stored accordingly.

To this end, when the user inputs the annotation information 130 to the electronic medical record system, whether the input annotation information 130 is the annotation area 115 or the annotation content 119 should be identified. Generally, since the annotation area 115 is an area marked in the medical reference image 110, it is a closed figure such as a circle or a quadrilateral. In addition, the annotation content 119 is content that is recognizable through handwriting recognition. Therefore, the annotation area 115 and the annotation content 119 can be distinguished from each other. Alternatively, whether the input annotation information 130 is the annotation area 115 or the annotation content 119 may be identified using an input menu on an annotation information input screen.

The following description will be given based on the assumption that the annotation area 115 is a closed figure. In addition, some users may input only the annotation area 115 and may not input the annotation content 119. That is, the following description will be given based on the assumption that the annotation area information 135 is an essential item in the annotation information 130 but that the annotation content text 139 is an optional item.

The clinical information 140 may include the patient's personal information, medical records, surgery records, medical test records, etc. More specifically, the clinical information 140 may include the patient's name, gender, age, blood type, name of disease, date of disease occurrence, diseased part, name of operation, date of operation, body part operated on, name of test, date of test, and body part tested, etc. Generally, the clinical information 140 is standardized data that is input to the electronic medical record system as given values for given items.

The annotation information 130 and the clinical information 140 are stored for each patient in the electronic medical record 120. In addition to the annotation information 130 and the clinical information 140, various other information can be stored. For example, information about the electronic medical record 120 such as information about the author of the electronic medical record 120 and the date of writing of the electronic medical record 120 can also be stored.

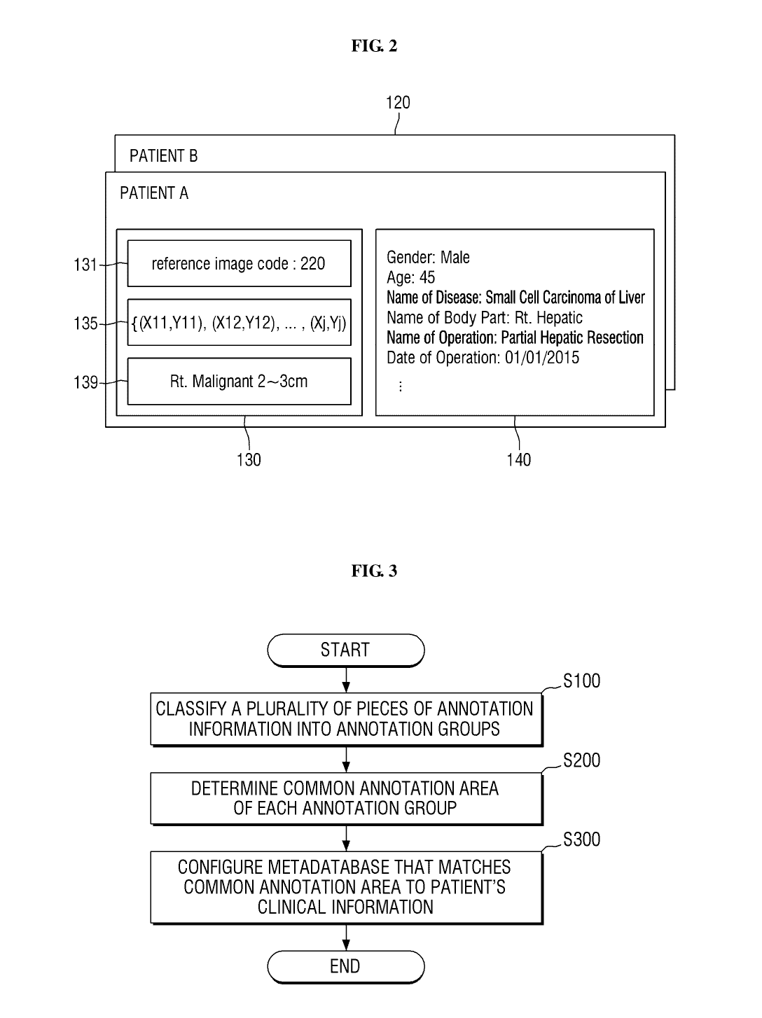

A method of processing the annotation area information 135, which is stored in the electronic medical record 120 as the vector data, into standardized data and utilizing the standardized data as medical information will now be described with reference to FIG. 3.

FIG. 3 is a flowchart illustrating a method of managing a medical metadatabase according to an embodiment of the present invention.

Referring to FIG. 3, a plurality of pieces of annotation information 130 are classified into annotation groups according to a predetermined classification standard (operation S100).

Here, each piece of annotation information 130 includes the annotation area information 135 and, in some cases, may include the annotation content text 139. Basically, it is assumed that the pieces of annotation information 130 included in the same medical reference image 110 are classified. That is, the pieces of annotation information 130 having the same value of the image information 131 may be classified into the annotation groups according to the predetermined classification standard.

The classifying of the pieces of annotation information 130 into the annotation groups (operation S100) is performed to standardize the pieces of annotation information 130. Since each piece of annotation information 130, in particular, the annotation area information 135 indicates an area input by a user onto the medical reference image 110, various values can be input as the annotation area information 135, unlike the clinical information 140 which is input as given values for given items. For this reason, if the pieces of annotation information 130 are standardized by classifying the pieces of annotation information 130 into the annotation groups and then determining a common annotation area of each annotation group, the utilization value of the pieces of annotation information 130 as medical information can be increased.

In addition, the classifying of the pieces of annotation information 130 into the annotation groups (operation S100) is performed to increase the accuracy of the pieces of annotation information 130. If a common annotation area is determined by overlapping annotation areas 115 as will be described later, the accuracy of information needed as medical information can further be increased.

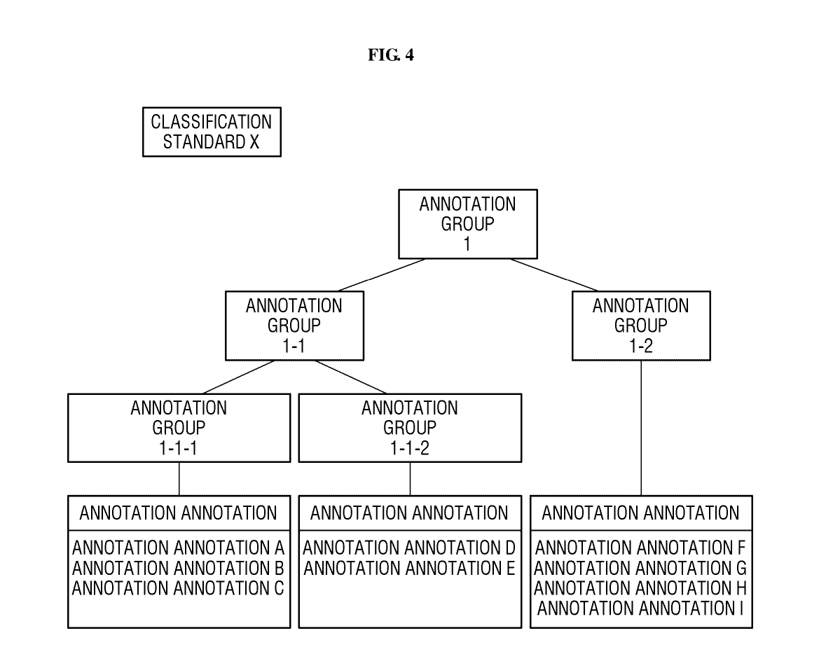

The utilization value of the pieces of annotation information 130 may vary according to which classification standard is used to classify the pieces of annotation information 130. A common annotation area for a particular body part or a particular disease can be obtained, and a common annotation area for a particular user or a particular patient can be obtained. The classification standard used to classify the pieces of annotation information 130 into the annotation groups will be described in more detail later together with another embodiment of the present invention in FIG. 4.

Next, a common annotation area of each annotation group is determined using the annotation area information 135 of each piece of annotation information 130 included in the annotation group (operation S200).

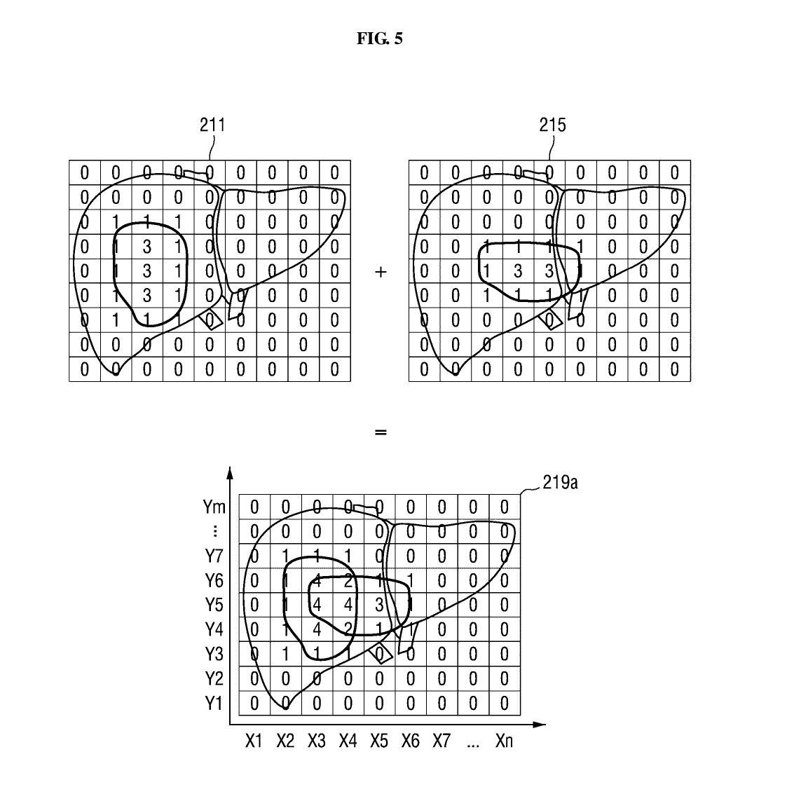

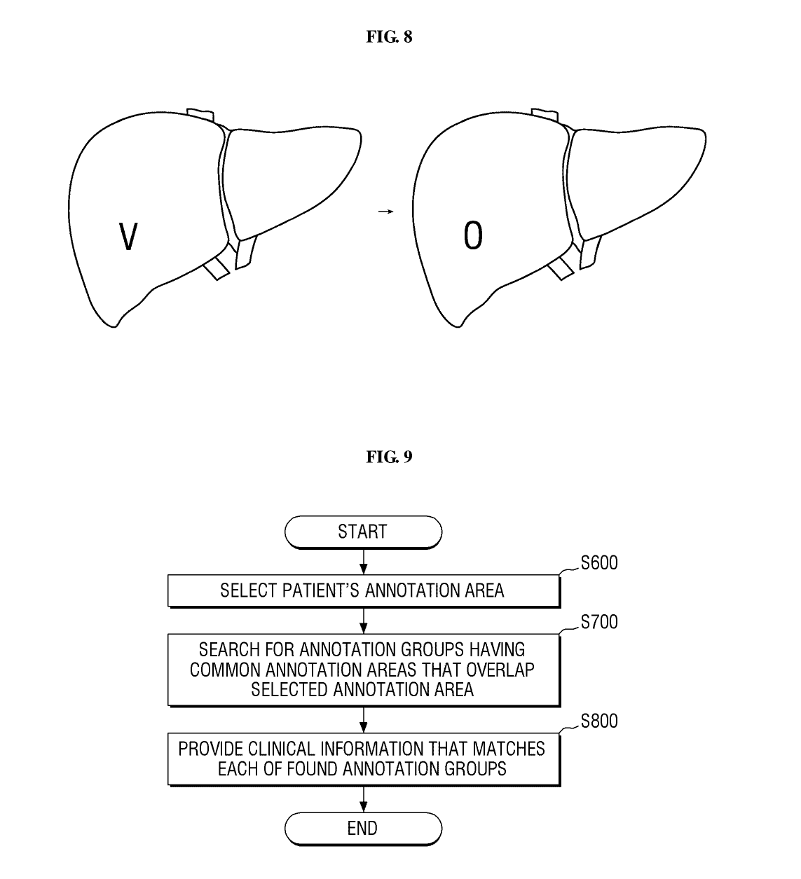

To determine the common annotation area, the method of managing a medical metadatabase may further include overlapping annotation areas 115 of the pieces of annotation information 130 included in each annotation group. In this case, items such as a weight and a reference value may be used additionally. This will be described in more detail later together with another embodiment of the present invention in FIGS. 5 through 8.

Finally, a metadatabase that matches a patient's clinical information 140 related to each piece of annotation information 130 in each annotation group to the common annotation area is configured (operation S300).

The metadatabase consists of the pieces of annotation information 130, which are processed into the annotation groups, the classification standard and the common annotation area, and the patient's clinical information 140 which matches each piece of annotation information 130. The pieces of annotation information 130 standardized as described above can be utilized as medical information through the metadatabase. This will be described in more detail later together with another embodiment of the present invention in FIGS. 9 through 12.

According to an embodiment of the present invention, the classifying of the pieces of annotation information 130 into the annotation groups (operation S100) may include classifying the pieces of annotation information 130 into the annotation groups by using major clinical information selected from the clinical information 140 of each patient as the classification standard.

Unlike each piece of annotation information 130, the clinical information 140 is standardized as given values for given items in the electronic medical record system. Therefore, a particular item can be selected from the given items as the major clinical information and used as the classification standard.

For example, the major clinical information may be one of the name of disease, the name of body part, and the name of operation. Alternatively, a plurality of pieces of major clinical information such as [name of disease-name of body part] may be used as the classification standard. Hereinafter, the major clinical information may be presented in brackets ‘[ ]’ when used as the classification standard.

The nature of each annotation group is determined depending on which item of the clinical information 140 is selected as the major clinical information and used as the classification standard. For example, when a user wants to view annotation areas 115 related to a particular disease in a medical reference image 110 of the liver, [name of disease] may be used as the classification standard. Alternatively, when the user wants to view annotation areas 115 related to a particular operation, [name of operation] may be used as the classification standard.

Alternatively, which item of the clinical information 140 will be selected as the major clinical information and used as the classification standard may be automatically determined based on a medical reference image 110.

For example, in the case of a medical reference image 110 of an internal organ such as the liver, stomach or small intestine, the clinical information 140 such as the name of operation may be treated as the major clinical information. In the case of a medical reference image 110 of the palm or sole, the clinical information 140 other than the name of operation may be treated as the major clinical information. In this case, items that can be selected as the major clinical information may be preset according to a medical reference image 110, and the major clinical information may be automatically selected from the preset items and used as the classification standard.

According to an embodiment of the present invention, the classifying of the pieces of annotation information 130 into the annotation groups (operation S100) may include classifying the pieces of annotation information 130 into the annotation groups by using the annotation content text 139 included in each piece of annotation information 130 as the classification standard.

When writing each piece of annotation information 130, a user may also input brief information about the annotation area 115. In the example of FIG. 1, the user input “Rt. Malignant 2-3 cm” as the annotation content text 139. Using this annotation content text 139, the pieces of annotation information 130 can be classified into the annotation groups. When the annotation content text 139 is used as the classification standard, the common annotation area of an annotation group having particular annotation content text 139 can be identified.

According to an embodiment of the present invention, the classifying of the pieces of annotation information 130 into the annotation groups (operation S100) may include classifying the pieces of annotation information 130 into the annotation groups by using the author of each piece of annotation information 130 as the classification standard.

Using the author as the classification standard can be understood as a kind of personalization function. That is, the pieces of annotation information 130 may be classified into the annotation groups by users who wrote electronic medical records 120, and the common annotation area of each annotation group can be identified. This classification standard may be more meaningful for medical specialists specialized in particular body parts and particular diseases.

The personalization function can be provided based not only on the author of each piece of annotation information 130 but also on each patient. That is, the pieces of the annotation information 130 can also be classified into the annotation groups using patients as the classification standard. For example, a particular patient may be classified as a particular annotation group, and the common annotation area of the particular annotation group can be identified. If the particular patient has undergone several operations or tests, information about the patient's major body part operated on or tested can be found in the common annotation area.

FIG. 4 is a diagram illustrating a tree structure of annotation groups that can be referred to in some embodiments of the present invention.

As described above, a plurality of pieces of major clinical information can be used as the classification standard. For example, an annotation group [name of disease: small cell carcinoma of the liver] of an upper node may include annotation groups of a lower node, such as [name of operation: partial hepatic resection] and [name of treatment: radiotherapy]. In a tree structure of annotation groups, a common annotation area of an annotation group of an upper node may be determined using a plurality of pieces of annotation information 130 included in each annotation group of a lower node.

Referring to FIG. 4, a common annotation area of annotation group 1 may be determined using annotation information A through I, a common annotation area of annotation group 1-1 may be determined using annotation information A through E, and a common annotation area of annotation group 1-1-1 may be determined using annotation information A through C. Using such a tree structure of annotation groups, a plurality of pieces of annotation information 130 can be standardized more systematically.

In addition, when the annotation content text 139 is used as the classification standard, a tree structure of annotation groups can be formed. When a user inputs “Rt. Malignant 2-3 cm” as the annotation content text 139 as illustrated in FIG. 1, a tree structure having [annotation content: Rt. Malignant] as an annotation group of an upper node and [range: 2˜5 cm], [range: 6˜9 cm] and [range: 10 cm˜] as annotation groups of a lower node can be formed.

When authors of the pieces of annotation information 130 are used as the classification standard, a tree structure of annotation groups can also be formed. For example, a tree structure of annotation groups can be formed using occupational groups and positions of the authors of the pieces of annotation information 130.

FIGS. 5 through 8 are diagrams illustrating various methods of overlapping annotation areas according to some embodiments of the present invention.

According to an embodiment of the present invention, the determining of the common annotation area of each annotation group (operation S200) may further include overlapping the annotation areas 115 of the pieces of annotation information 130 included in each annotation group.

To overlap the annotation areas 115, a method suggested by Segenreich and Braga (1986) can be used. As described above, the annotation areas 115 may be closed figures. A closed figure can divide an area into the outside, a boundary line, and the inside. For each annotation area 115 in the medical reference image 110, a value of zero may be allocated to the outside, a value of one may be allocated to the boundary line, and a value of three may be allocated to the inside. Then, the annotation areas 115 of the pieces of annotation information 130 included in each annotation group may be overlapped. As a result, a particular area having a high overlap value which is defined as the sum of the allocated values may be determined to be the common annotation area of each annotation group.

Referring to FIG. 5, when annotation area A (211) and annotation area B (215) are overlapped, a common annotation area X1 (219a) can be obtained. The common annotation area X1 (219a) may be determined to be vector data {(x3,y4), (x3,y5), (x3,y6), (x4,y5)} having an overlap value of four.

If a plurality of annotation areas 115 are overlapped as described above, the accuracy of the common annotation area as medical information can be increased. For example, when an annotation group of FIG. 5 is [name of body part: right part of the liver], a user may mark the right part of the liver as annotation area A (211), and another user may mark the right part of the liver as annotation area B (215). Here, a common annotation area that can be generally referred to as the right part of the liver may be determined by overlapping the two annotation areas 115, i.e., annotation area A (211) and annotation area B (215).

According to an embodiment of the present invention, the overlapping of the annotation areas 115 of the pieces of annotation information 130 included in each annotation group may include overlapping the annotation areas 115 of the pieces of annotation information 130 included in each annotation group after giving different weights to the annotation areas 115 of the pieces of annotation information 130 included in each annotation group.

When a plurality of annotation areas 115 are overlapped, it is not necessary to overlap all of the annotation areas 115 at the same ratio. In some cases, the annotation areas 115 may be overlapped after a higher weight is given to a particular annotation area 115.

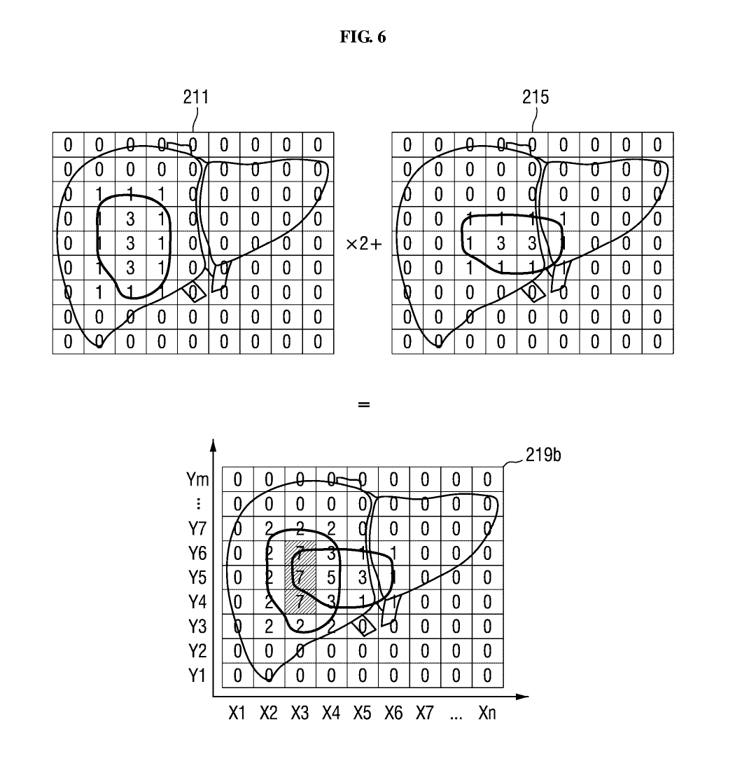

Referring to FIG. 6, annotation area A (211) and annotation area B (215) may be overlapped after a weight twice higher than that of annotation area B (215) is given to annotation area A (211). The result is a common annotation area X2 (219b) which is different from the common annotation area X1 (219a) obtained by overlapping annotation area A (211) and annotation area B (215) at a ratio of 1:1. When annotation area A (211) and annotation area B (215) are overlapped at a ratio of 2:1, the common annotation area X2 (219b) may be determined to be vector data {(x3,y4), (x3,y5), (x3,y6)}.

When a plurality of annotation areas 115 are overlapped, which annotation area 115 will be given a higher weight may be determined based on various standards. For example, the annotation areas 115 may be weighted differently according to the dates of writing of the pieces of annotation information 130. In an annotation group classified using a particular name of disease as the classification standard, the annotation areas 115 may be overlapped after a higher weight is given to a more recently written piece of annotation information 130. In this case, the common annotation area may vary according to a change in the occurrence time of the particular disease. Alternatively, in an annotation group classified using a particular patient as the classification standard, the annotation areas 115 may be overlapped after a higher weight is given to a more recently written piece of annotation information 130. In this case, the common annotation area may vary according to a development in the patient's disease over time.

In addition, a weight may be determined according to the author of each of the pieces of annotation information 130. For example, a different weight may be given according to an author's occupational group and position. That is, a different weight may be given according to whether an annotation area 115 has been created by a doctor or a nurse. Even among doctors, a different weight may be given according to whether an annotation area 115 has been created by a medical specialist or an intern.

Alternatively, a different weight may be given according to information about an annotation area 115 itself. For example, a weight may be determined according to the circumference or size of the annotation area 115. For the same right part of the liver, there may be a wide annotation area 115 and a narrow annotation area 115. In this case, the narrow annotation area 115 may provide more accurate information. Therefore, the two annotation areas 115 may be overlapped after a higher weight is given to the narrow annotation area 115.

According to an embodiment of the present invention, the determining of the common annotation area of each annotation group (operation S200) may include determining an annotation area 115, whose overlap value obtained by overlapping the annotation areas 115 of the pieces of annotation information 130 included in each annotation group is equal to or greater than a reference value, to be the common annotation area

When the common annotation area is determined, an area having a highest overlap value is not necessarily determined to be the common annotation area. In some cases, an area having an overlap value equal to or greater than a particular reference value may be determined to be the common annotation area.

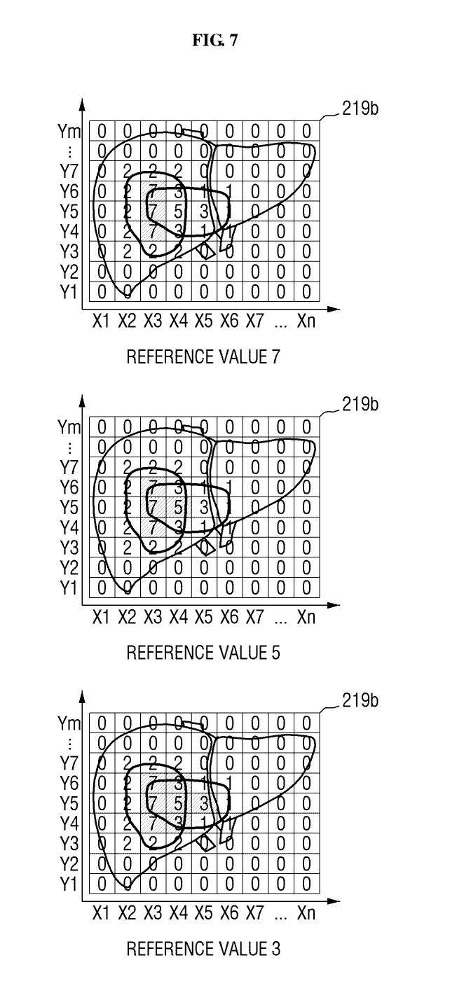

Referring to FIG. 7, for the same result of overlapping the annotation areas 115, a different common annotation area may be determined according to a reference value. Vector data {(x3,y4), (x3,y5), (x3,y6)} for a reference value of seven or more, vector data {(x3,y4), (x3,y5), (x3,y6), (x4,y5)} for a reference value of six or more, and {(x3,y4), (x3,y5), (x3,y6), (x4,y4), (x4,y5), (x4,y6), (x5,y5)} for a reference value of three or more may be determined to be the common annotation area.

Generally, a high reference value reduces the common annotation area while increasing the accuracy of the common annotation area. On the other hand, a low reference value increases the common annotation area while reducing the accuracy of the common annotation area. As the accuracy of the common annotation area is higher, it is more desirable. However, if the reference value is set too high in order to increase the accuracy of the common annotation area, the common annotation area may be almost always determined to be particular coordinates. In this case, the utilization value of the common annotation area as medical information is reduced. For this reason, it is important to set an appropriate reference value.

To set the reference value, the classification standard for classifying the pieces of annotation information 130 into the annotation groups can be used. As in the above example, when there are annotation groups [name of operation: partial hepatic resection] and [name of treatment: radiotherapy], the size of each annotation area 115 meaningful as medical information may be different in each of the annotation groups. While an operation is performed on a particular body part having a tumor, radiotherapy may be performed on a wider area than the particular body part. In this case, a higher reference value may be set for the annotation group which is classified using ‘the name of operation’ as the classification standard.

Another standard for setting the reference value may be the number of annotation areas 115 to be overlapped. As the number of annotation areas 115 to be overlapped increases, the accuracy of the common annotation area increases. Therefore, the utilization value of the common annotation area as medical information can be secured by setting the reference value somewhat low, and the accuracy of the common annotation area can be increased by overlapping a greater number of annotation areas 115.

According to an embodiment of the present invention, the determining of the common annotation area of each annotation group (operation S200) may further include, if the annotation areas 115 of the pieces of annotation information 130 included in each annotation group are not closed figures, correcting the annotation areas 115 to closed figures.

Until now, overlapping the annotation areas 115 based on the assumption that the annotation areas 115 are closed figures has been described. However, some users may mark the annotation areas 115 as open figures. For example, a user may mark the annotation areas 115 with ‘v’. In this case, vector data marked with ‘v’ can be used as the annotation areas 115 to be overlapped. However, if the ‘v’ marks are used as the annotation areas 115 without a modification, the annotation areas 115 cannot be properly reflected because only a boundary line exists in each of the ‘v’ marks. In this case, to overlap the annotation areas 115, each of the ‘v’-shaped annotation areas 115 may be corrected to an annotation area 115 shaped like a circle having a predetermined size and a vertex of the ‘v’ mark at its center. Here, the size of the circle may be determined to be an average size of the annotation areas 115 included in each annotation group.

Until now, a method of configuring a metadatabase using a patient' annotation information 130 added onto a medical reference image 110 has been described. In summary, the annotation information 130 can be standardized using an annotation group, and the accuracy of a common annotation area can be secured by overlapping annotation areas 115. In addition, the annotation information 130 can be easily searched for and retrieved by matching the standardized annotation information 130 with the patient's clinical information 140.

A method of searching a medical metaldatabase will now be described with reference to FIGS. 9 through 12.

FIG. 9 is a flowchart illustrating a method of searching a medical metadatabase according to an embodiment of the present invention.

Referring to FIG. 9, a user's input for selecting an annotation area 115 in a medical reference image 110 is received (operation S600). Here, the annotation area 115 selected by the user is converted into vector data and utilized to search a metadatabase.

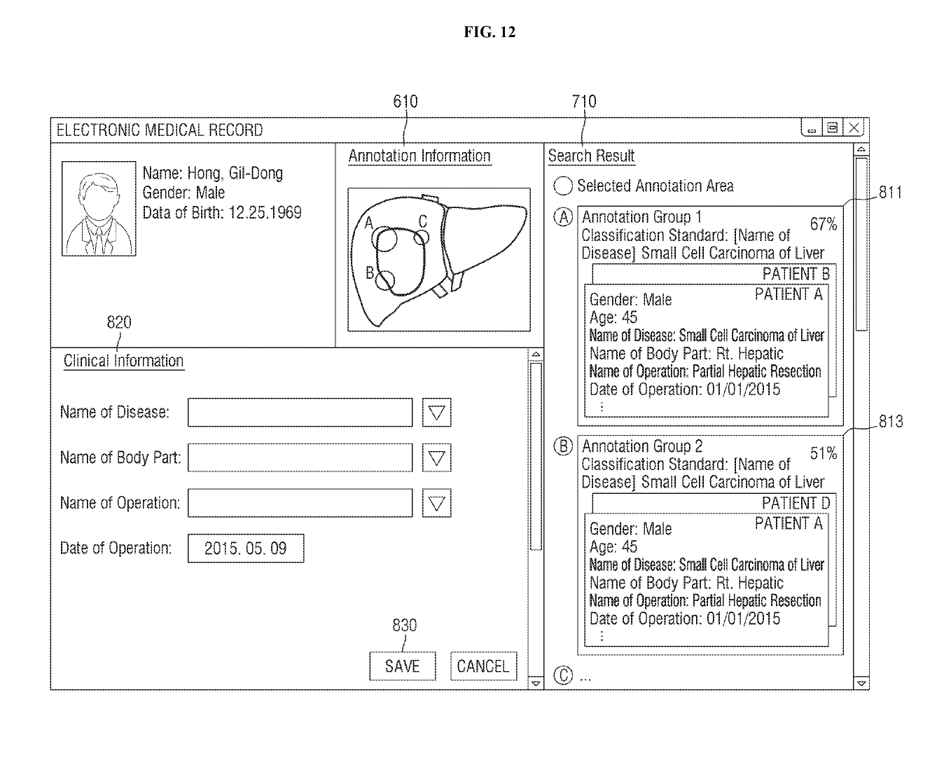

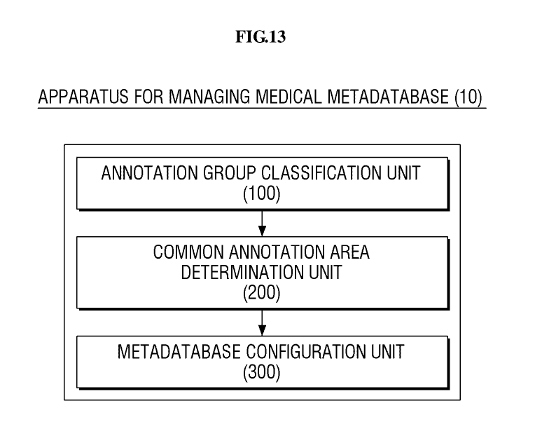

Next, annotation groups having common annotation areas that overlap the selected annotation area 115 are searched for in the metadatabase (operation S700). The importance of each of the found annotation groups may be determined according to an overlap rate between the common annotation area and the selected annotation area 115. This will be described in more detail later together with another embodiment of the present invention in FIG. 12.

Finally, a patient's clinical information 140 related to each piece of annotation information 130 included in each of the found annotation groups is provided (operation S800). The found annotation groups and the clinical information 140 can ensure convenience on an electronic medical record writing screen. This will be described in more detail later together with another embodiment of the present invention in FIG. 12.

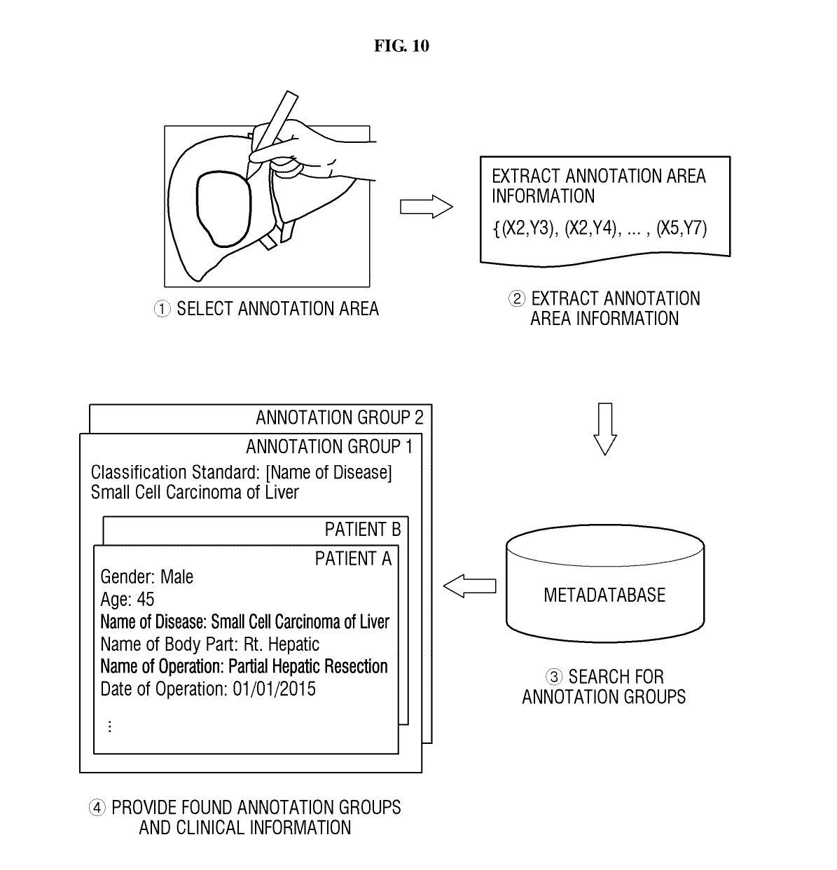

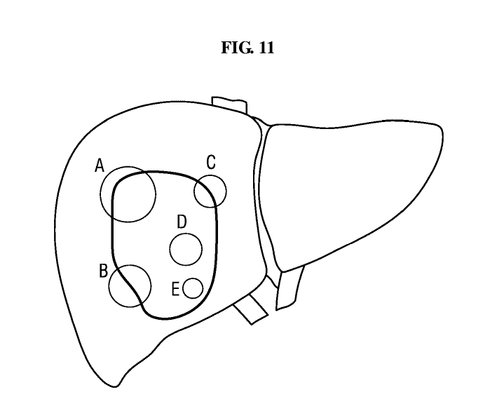

FIG. 10 is a diagram illustrating a process of searching a medical metadatabase according to embodiments of the present invention.

Referring to FIG. 10, when a user selects an annotation area 115, annotation area information 135 is extracted from the annotation area 115. Then, annotation groups having common annotation areas that overlap the annotation area 115 are searched for in a metadatabase. The found annotation groups and clinical information 140 that matches each of the found annotation groups are provided to the user. Accordingly, the user can search for and retrieve annotation information 130 and the clinical information 140 related to a particular area in a medical reference image 110.

According to an embodiment of the present invention, to search the metadatabase, the user may input a keyword instead of the annotation area 115. When the user inputs a particular keyword, annotation groups having classification standards similar to the keyword may be searched for, and the found annotation groups and a common annotation area of each of the found annotation groups may be retrieved. For example, when the user enters ‘liver cancer’ on a keyword input window, an annotation group having [name of disease: liver cancer] as the classification standard may be searched for. Accordingly, the found annotation group and a common annotation area of the found annotation group may be displayed on the screen for the user. In this way, the user can identify a common annotation area related to a particular keyword.

FIG. 11 is a diagram illustrating a process of searching for a common annotation area according to embodiments of the present invention.

According to an embodiment of the present invention, the searching for of the annotation groups having the common annotation areas that overlap the selected annotation area 115 in the metadatabase (operation S700) may include searching for annotation groups having common annotation areas that are completely overlapped by the selected annotation area 115 in the metadatabase.

Referring to FIG. 11, only common annotation areas D and E are completely overlapped by the selected annotation area 115. Since common annotation areas A, B and C are overlapped only partially by the selected annotation area 115, they are excluded from search results if a search condition is changed to ‘complete overlap.’ That is, different common annotation areas may be searched for when the search condition is set to ‘partial overlap’ and ‘complete overlap.’ Generally, when the search condition is set to ‘complete overlap,’ annotation groups having common annotation areas that overlap the selected annotation area 115 can be found more accurately.

FIG. 12 is a diagram illustrating an example graphic user interface (GUI) for writing an electronic medical record according to embodiments of the present invention.

According to an embodiment of the present invention, the providing of the patient's clinical information 140 (operation S800) may further include listing the found annotation groups based on overlap rates between the selected annotation area 115 and the common annotation areas.

According to an embodiment of the present invention, the receiving of the user's input (operation S600) in the method of searching a medical metadata may include receiving the user's input through the electronic medical record writing screen, and the providing of the patient's clinical information 140 (operation S800) may include providing the patient's clinical information 140 on the electronic medical record writing screen.

Referring to FIG. 12, a user selects an annotation area 115 for a patient ‘Hong Gil-Dong’ in an annotation information input section 610 of the electronic medical record writing screen. Then, annotation groups having common annotation areas that overlap the selected annotation area 115 are searched for in a metadatabase, and the found annotation groups and clinical information 140 that matches each of the found annotation groups are provided together in a search results section 710. By referring to search results provided in the search results section 710, the user enters clinical information 140 of the patient ‘Hong, Gil-Dong’ in a clinical information input section 820.

Here, assuming that the annotation groups having the common annotation groups that overlap the selected annotation area 115 are found to be annotation group 1 (811) and annotation group 2 (813), the importance of each of annotation group 1 (811) and annotation group 2 (813) may be determined according to an overlap rate between the common annotation area and the selected annotation area 115. Generally, an annotation group having a common annotation area that overlaps a greater portion of the selected annotation area 115 may be regarded as more important medical information. The overlap rate between the common annotation area and the selected annotation area 115 can be obtained by dividing the size of a portion of the common annotation area which overlaps the selected annotation area 115 by the size of the selected annotation area 115. An annotation group having a higher overlap rate between the common annotation area and the selected annotation area 115 may be similar to the clinical information 140 of the patient ‘Hong, Gil-dong.’ Therefore, the annotation group may be provided at the top of the search results section 710.

In the example of FIG. 12, annotation group 2 (813) has an overlap rate of 51%, and annotation group 1 (811) has an overlap rate of 67%. Therefore, since the importance of annotation group 2 (813) is higher, annotation group 2 (813) may be provided at the top of the search results section 710.

According to an embodiment of the present invention, the providing of the patient's clinical information 140 (operation S800) may further include recommending a clinical information input value of the electronic medical record writing screen by using the patient's clinical information 140.

That is, the search results may not only be retrieved and provided in the search results section 710 but also be used to recommend information about an annotation group having higher importance and a common annotation area similar to the selected annotation area 115 as a clinical information input value on the electronic medical record writing screen.

For example, in FIG. 12, the classification standard [name of disease: small cell carcinoma of the liver] of annotation group 1 (811) having higher importance may be recommended as a clinical information input value of the patient ‘Hong, Gil-dong’. This recommendation can be made by automatically selecting small cell carcinoma of the liver for the ‘name of disease’ item of the clinical information input section 820. In this case, the user can write an electronic medical record 120 more easily.

According to an embodiment of the present invention, the method of searching the medical metadatabase may further include, if the user stores the electronic medical record 120, updating the metadatabase using the annotation information 130 and the clinical information 140 in the electronic medical record 120.

The present invention may include not only configuring the metadatabase using the annotation information 130 but also updating the metadatabase by reflecting the electronic medical record 120 written after the configuring of the metadatabase. That is, as more electronic medical records 120 accumulate in the metadatabase, the accuracy of the common annotation area of each annotation group and the utilization value of the metadatabase can be increased.

For example, when the user stores the electronic medical record 120 of the patient ‘Hong, Gil-dong’ by clicking on a Save button 830, the annotation information 130 and the clinical information 140 of the patient ‘Hong, Gil-dong’ may be reflected in annotation group 1 (811) or annotation group 2 (813) in the search results section 710. Accordingly, this can increase the accuracy of the common annotation area of annotation group 1 (811) or annotation group 2 (813).

FIG. 13 is a block diagram of an apparatus 10 for managing a medical metadatabase according to an embodiment of the present invention.

According to an embodiment of the present invention, the apparatus 10 for managing a medical metadatabase may include an annotation group classification unit 100 which classifies a plurality of pieces of annotation information into annotation groups according to a predetermined classification standard, a common annotation area determination unit 200 which determines a common annotation area of each annotation group using annotation area information of each piece of annotation information included in each annotation group, and a metadatabase configuration unit 300 which configures a metadatabase that matches a patient's clinical information related to each piece of annotation information included in each annotation group to the common annotation area. Here, each piece of annotation information includes the annotation area information in a medical reference image.

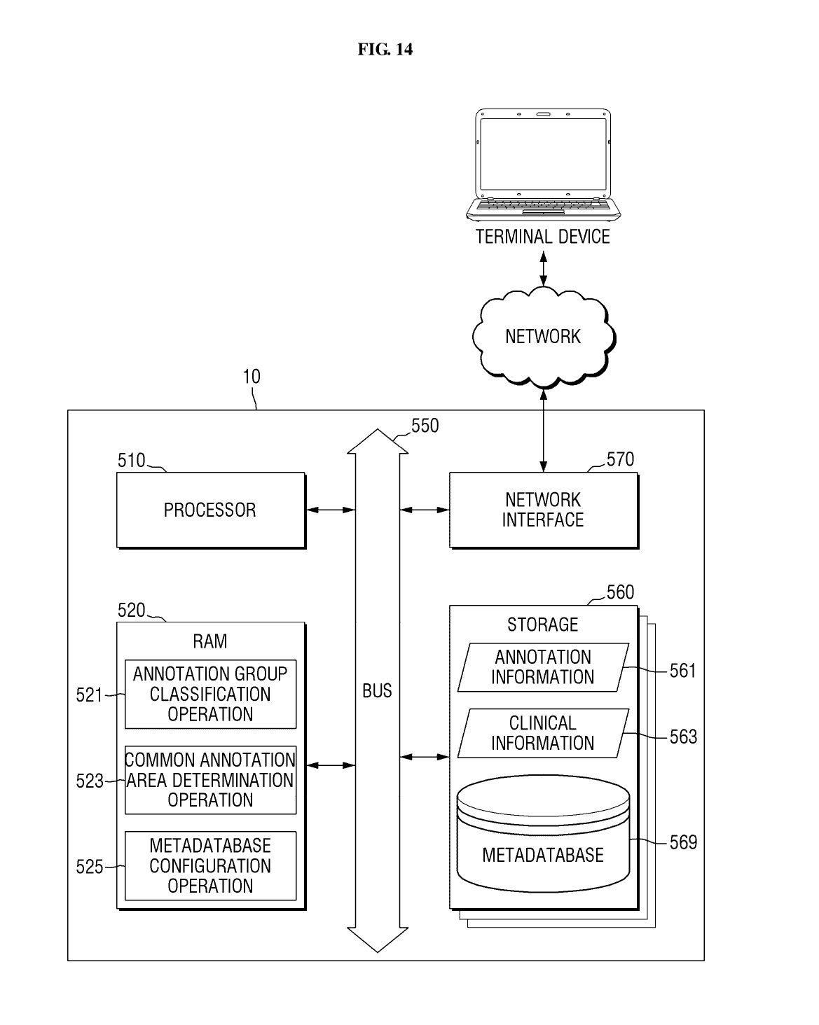

FIG. 14 is a diagram illustrating the hardware configuration of the apparatus 10 of FIG. 13.

Referring to FIG. 14, the apparatus 10 for managing a medical metadatabase may include one or more processors 510, a memory 520, a storage 560, and an interface 570. The processors 510, the memory 520, the storage 560 and the interface 570 may transmit and receive data through a system bus 550.

The processors 510 may execute a computer program loaded into the memory 520. The memory 520 may load the computer program from the storage 560. The computer program may include an annotation group classification operation 521, a common annotation area determination operation 523, and a metadatabase configuration operation 525.

The annotation group classification operation 521 may load a plurality of pieces of annotation information 561 stored in the storage 560 into the memory 520 through the system bus 550. Then, the annotation group classification operation 521 may classify the pieces of annotation information 561 into annotation groups according to a predetermined classification standard.

The common annotation area determination operation 523 may determine a common annotation area of each annotation group using annotation area information of each piece of annotation information included in each annotation group.

The metadatabase configuration operation 525 may configure a metadatabase by loading clinical information 563 stored in the storage 560 into the memory 520 and matching the clinical information 563 to the common annotation area. The metadatabase configured in the memory 520 is stored as a metadatabase 569 in the storage 560 through the system bus 550.

The apparatus 10 for managing a medical metadatabase provides an interface needed to search a metadatabase through a network interface 570.

Each component of FIG. 14 means, but is not limited to, a software component or a hardware component such as a Field Programmable Gate Array (FPGA) or Application Specific Integrated Circuit (ASIC). A component may advantageously be configured to reside on the addressable storage medium and configured to execute on one or more processors. The functionality provided for in the components may be combined into fewer components or further separated into additional components.

According to the present invention, annotation information about a patient which is added onto a medical reference image is standardized using an annotation group. Therefore, the utilization value of the annotation information as medical information can be increased.

In addition, a common annotation area of an annotation group is determined using annotation area information of each piece of annotation information included in the annotation group. Therefore, the accuracy of the common annotation area can be increased.

Furthermore, when writing an electronic medical record, a user is provided with a common annotation area and clinical information that matches the common annotation area. Therefore, the user can write the electronic medical record more easily and conveniently.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method of managing a medical metadatabase, the method comprising:
classifying a plurality of pieces of annotation information into an annotation group according to a predetermined classification standard, each of the plurality of pieces of annotation information comprising annotation area information and corresponding clinical information;
determining a common annotation area of the annotation group using the annotation area information of each of the plurality of pieces of annotation information classified into the annotation group; and
configuring a metadatabase which matches the corresponding clinical information of each of the plurality of pieces of annotation information classified into the annotation group to the common annotation area of the annotation group,
wherein each of the plurality of pieces of annotation information comprises an annotation area in a medical reference image.

2. The method of claim 1, wherein the classifying the plurality of pieces of annotation information into the annotation group comprises classifying the plurality of pieces of annotation information into the annotation group using a portion of the corresponding clinical information of each of the plurality of pieces of annotation information as the predetermined classification standard.

3. The method of claim 2, wherein the portion of the corresponding clinical information is one of a name of a disease, a name of a body part, and a name of an operation.

4. The method of claim 2, wherein the portion of the corresponding clinical information is automatically selected from the corresponding clinical information of each of the plurality of pieces of annotation information based on the medical reference image.

5. The method of claim 1, wherein each of the plurality of pieces of annotation information further comprises annotation content text, and the classifying the plurality of pieces of annotation information into the annotation group comprises classifying the plurality of pieces of annotation information into the annotation group using the annotation content text of each of the plurality of pieces of annotation information as the predetermined classification standard.

6. The method of claim 1, wherein the classifying the plurality of pieces of annotation information into the annotation group further comprises configuring a tree structure the annotation group as a node.

7. The method of claim 1, wherein the determining the common annotation area of the annotation group comprises overlapping the annotation area of each of the plurality of pieces of annotation information classified into the annotation group.

8. The method of claim 7, wherein the determining the common annotation area of the annotation group further comprises determining a reference annotation area having an overlap value greater than or equal to a reference value to be the common annotation area, wherein the overlap value is obtained by overlapping the annotation area of each of the plurality of pieces of annotation information classified into the annotation group.

9. The method of claim 7, wherein the overlapping of the annotation area of each of the plurality of pieces of annotation information classified into the annotation group comprises overlapping the annotation area of each of the plurality of pieces of annotation information classified into the annotation group after assigning a respective weight to the annotation area of each of the plurality of pieces of annotation information classified into the annotation group.

10. The method of claim 9, wherein the respective weight is assigned based on a respective size of the annotation area.

11. The method of claim 1, wherein the determining the common annotation area of the annotation group comprises, if at least one annotation area from among the annotation area of each of the plurality of pieces of annotation information is not a closed figure, correcting the at least one annotation area to a closed figure.

12. A method of searching a medical metadatabase, the method comprising:
receiving a user's input for selecting an annotation area in a medical reference image;
searching a metadatabase for annotation groups having a common annotation area that overlaps the annotation area selected by the user's input; and
providing clinical information corresponding to each piece of annotation information included in each of one or more found annotation group.

13. The method of claim 12, wherein the searching of the metadatabase for the annotation groups comprises searching the metadatabase for annotation groups having a common annotation area which are completely overlapped by the annotation area selected by the user's input.

14. The method of claim 12, wherein the providing clinical information comprises displaying the one or more found annotation groups based on an overlap rate between the annotation area selected by the user's input and a common annotation area of each of the one or more found annotation groups.

15. The method of claim 12, wherein the receiving the user's input comprises receiving the user's input through an electronic medical record writing screen, and the providing clinical information comprises providing clinical information on the electronic medical record writing screen.

16. The method of claim 15, wherein the providing clinical information further comprises recommending a clinical information input value of the electronic medical record writing screen using the clinical information.

17. The method of claim 15, further comprising:
storing an electronic medical record comprising annotation information and clinical information, and
updating the medical metadatabase using the annotation information and the clinical information of the electronic medical record.

18. An apparatus for managing a medical metadatabase, the apparatus comprising:
an annotation group classification unit which classifies a plurality of pieces of annotation information into an annotation group according to a predetermined classification standard, each of the plurality of pieces of annotation information comprising annotation area information and corresponding clinical information;
a common annotation area determination unit which determines a common annotation area of the annotation group using the annotation area information of each of the plurality of pieces of annotation information classified into the annotation group; and
a metadatabase configuration unit which configures a metadatabase that matches the corresponding clinical information of each of the plurality of pieces of annotation information classified into the annotation group to the common annotation area of the annotation group,
wherein each of the plurality of pieces of annotation information comprises an annotation area in a medical reference image.
